(19) United States
(12) Patent Application Publication
(10) Pub. No.: US 2022/0222297 A1
(43) Pub. Date: Jul. 14, 2022

(54) GENERATING SEARCH RESULTS BASED ON AN AUGMENTED REALITY SESSION

(71) Applicant: Capital One Services, LLC, McLean, VA (US)

(72) Inventors: Chih-Hsiang CHOW, Coppell, TX (US); Steven DANG, Plano, TX (US); Elizabeth FURLAN, Plano, TX (US)

(21) Appl. No.: 17/149,523

(22) Filed: Jan. 14, 2021

(51) Int. Cl. G06F 16/908; G06F 16/9532; G06T 19/00; G06F 16/9538; G06F 16/9537

(52) U.S. Cl. CPC G06F 16/908; G06F 16/9532; G06F 16/9537; G06F 16/9538; G06T 19/006

(57) ABSTRACT

An image processing system may receive a set of images and may detect a plurality of features of an object included in the set of images. The image processing system may determine metadata associated with the set of images that indicates a relative importance of a first feature, of the plurality of features, as compared to a second feature, of the plurality of features. The image processing system may select, based on the metadata, a set of features of the plurality of features and may perform a search based on the set of features to identify a set of objects having a same object category as the object and that have a visual characteristic that shares a threshold degree of similarity with a corresponding visual characteristic of at least one feature included in the set of features. The image processing system may output results that identify the set of objects.

### BACKGROUND

A search engine may be used to perform a web search. For example, a user may input a search query via a web browser, which may cause the search engine to return search results based on the search query. In some cases, a search engine may include an image search engine that returns images based on the search query.

### SUMMARY

In some implementations, a system for generating search results based on data captured by an augmented reality device includes a memory and one or more processors, communicatively coupled to the memory, configured to: receive a set of images captured by the augmented reality device; detect a set of features included in the set of images, wherein the set of features includes different features of an object associated with an object category; determine metadata associated with the set of images, wherein the metadata includes at least one of: timing data that indicates a length of time that a detected feature, of the set of features, is displayed via a user interface of the augmented reality device, sequence data that indicates a sequence in which two or more features, of the set of features, are displayed via the user interface, distance data that indicates a distance between a detected feature, of the set of features, and the augmented reality device, or size data that indicates a size of a detected feature, of the set of features, on the user interface; select one or more detected features, of the set of features, based on the metadata; perform a search using an image repository and based on the one or more detected features to identify a set of objects associated with the object category; and transmit search results, that identify the set of objects, to another device.

In some implementations, a method for generating search results based on data captured by an augmented reality device includes receiving, by a system and from the augmented reality device, a set of images captured during an augmented reality session of the augmented reality device; detecting, by the system, a plurality of features included in the set of images, wherein the plurality of features includes different features of an object; determining, by the system, metadata associated with the set of images, wherein the metadata indicates a relative importance of a first feature, of the plurality of features, as compared to a second feature, of the plurality of features, based on augmented reality session data other than a user interaction with a user interface of the augmented reality device to explicitly indicate the relative importance; selecting, by the system and based on the metadata, a set of features of the plurality of features; performing, by the system, a search based on the set of features to identify a set of objects having a same object category as the object and that have a visual characteristic that shares a threshold degree of similarity with a corresponding visual characteristic of at least one feature included in the set of features; and outputting, by the system, search results that identify the set of objects.

In some implementations, a non-transitory computer-readable medium storing a set of instructions includes one or more instructions that, when executed by one or more processors of an augmented reality device, cause the augmented reality device to: capture a set of images during an augmented reality session; determine a plurality of features included in the set of images, wherein the plurality of features includes different features of an object; determine metadata associated with the set of images, wherein the metadata indicates an importance of a feature, of the plurality of features, based on augmented reality session data other than a user interaction with a user interface of the augmented reality device to explicitly indicate the importance; filter the plurality of features to identify a set of features based on the metadata; identify a subset of images, of the set of images, that include the set of features; and transmit the subset of images to a device.

### BRIEF DESCRIPTION OF THE DRAWINGS

FIGS. 1A-1E are diagrams of an example implementation associated with generating search results based on an augmented reality (AR) session.

FIG. 2 is a diagram of an example environment in which systems and/or methods described herein may be implemented.

FIG. 3 is a diagram of example components of one or more devices of FIG. 2.

FIGS. 4 and 5 are flowcharts of example processes relating to generating search results based on an AR session.

### DETAILED DESCRIPTION

The following detailed description of example implementations refers to the accompanying drawings. The same reference numbers in different drawings may identify the same or similar elements.

A search engine may allow users to search for images of products and/or product descriptions corresponding to the images. In some cases, the search engine may allow users to input search parameters to search for images of products and/or product description data that matches the search parameters. As a specific example, a user may search for vehicles based on high-level vehicle characteristics, such as a year, make, and/or model of a vehicle, a color of a vehicle, or a price or price range of a vehicle.

However, searching based on high-level product characteristics may not provide the user with optimal search results that are most relevant to the user. For example, the user may want to view images of products with characteristics that are difficult to describe using a textual search query (e.g., a taillight shape, a hubcap design, and/or a window tinting of a vehicle). As another example, the user may not know or be able to identify or describe the characteristics that are important to the user. In many of these cases, the search engine will be unable to provide search results that satisfy needs of the user because the search results will be identified based on incorrect or absent search parameters. This wastes resources (e.g., processing resources, network resources, and/or memory resources) by identifying and providing a user device with sub-optimal search results that will not be of interest to the user and that are unlikely to assist the user in making a product purchasing decision. This may also lead to excessive web browsing and web navigation as the user attempts to identify relevant products that were not identified in the search results or were not highly ranked in the search results.

Some implementations described herein provide an AR device and an image processing system that facilitate generating search results based on an AR session. The AR device may capture a set of images (e.g., using a camera of the AR device) associated with an object (e.g., a product) during an AR session and may determine one or more features of the object. The AR device may provide the set of images to the image processing system, which may determine metadata that indicates a relative importance of features of the object. The metadata may include, for example, timing data that indicates a length of time that a feature is displayed on a user interface of the AR device, sequence data that indicates a sequence in which features are displayed on the user interface, distance data that indicates a distance between a feature and the AR device, size data that indicates a size of a feature in an image or a proportion of an image occupied by the feature, and/or quantity data that indicates a quantity of images that include a feature. Based on the metadata, the image processing system may select a set of features that are determined to be important to a user of the AR device and may perform a search to identify a set of objects that have similar features as the set of features. The image processing system may transmit search results, that identify the set of objects, to the AR device for display.

In this way, the image processing system may provide the user of the AR device with more relevant search results (e.g., based on features of an object that are important to the user) as compared to a search engine that performs a textual search without accounting for inferences about the relative importance of the object features based on metadata obtained from an AR session and/or a set of images that includes the object. Further, by basing a search on metadata that does not include information concerning user interactions with a user interface of the AR device (e.g., user interactions with AR content presented during the AR session), the image processing system may infer important object features that the user does not even realize are important or that the user is unable to verbalize, and thus would be unable to input using a textual search query. As a result, some implementations described herein conserve resources that would otherwise have been used to search for, obtain, transmit, and display sub-optimal search results that would not be of interest to the user. Furthermore, some implementations described herein conserve resources that would otherwise be used when sub-optimal results cause the user to continue searching for images of objects that are not returned in the sub-optimal search results.

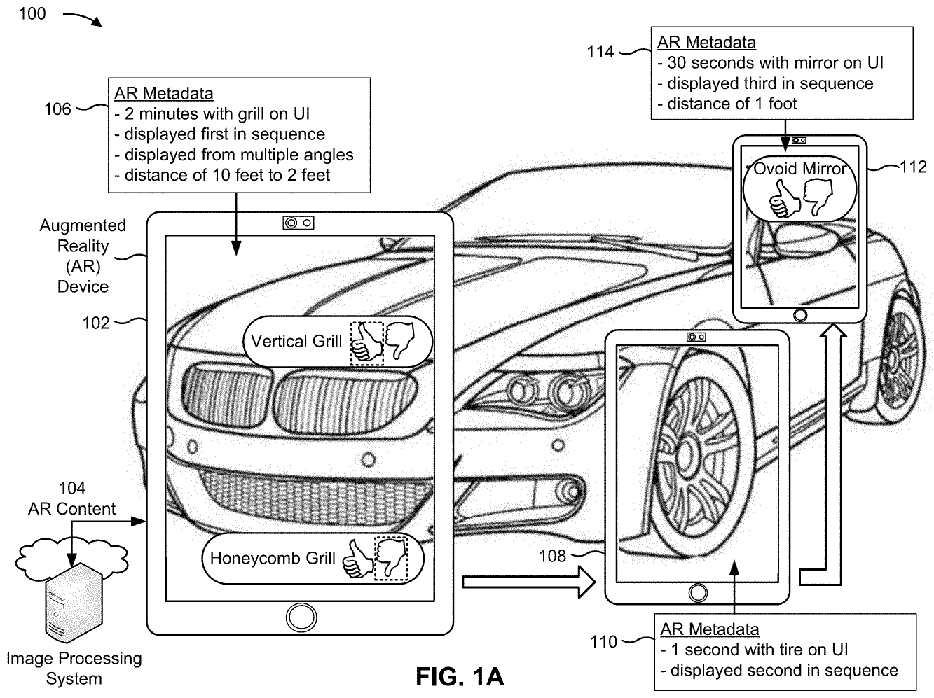

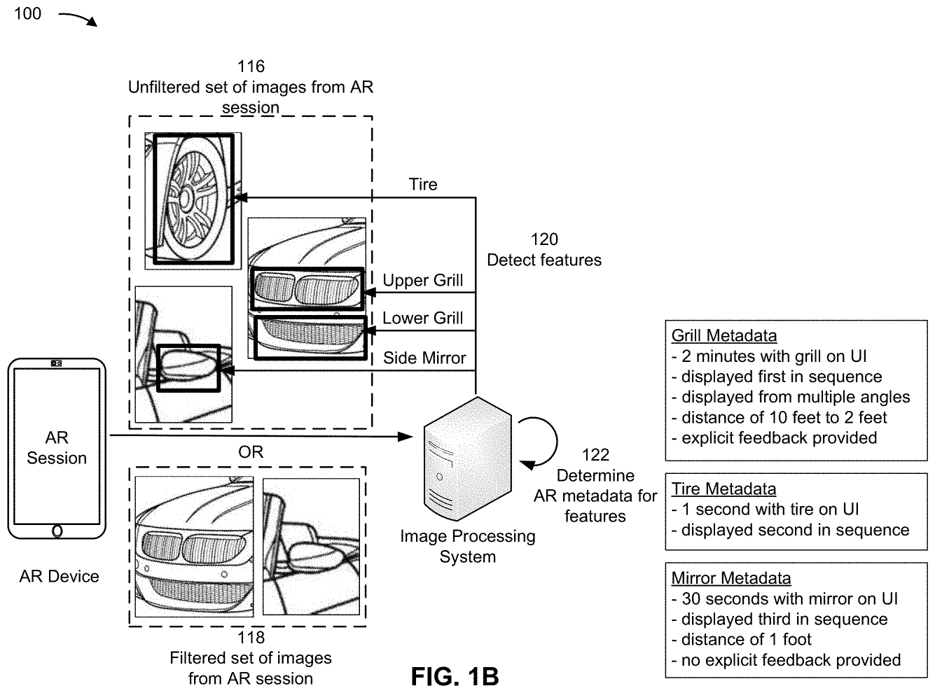

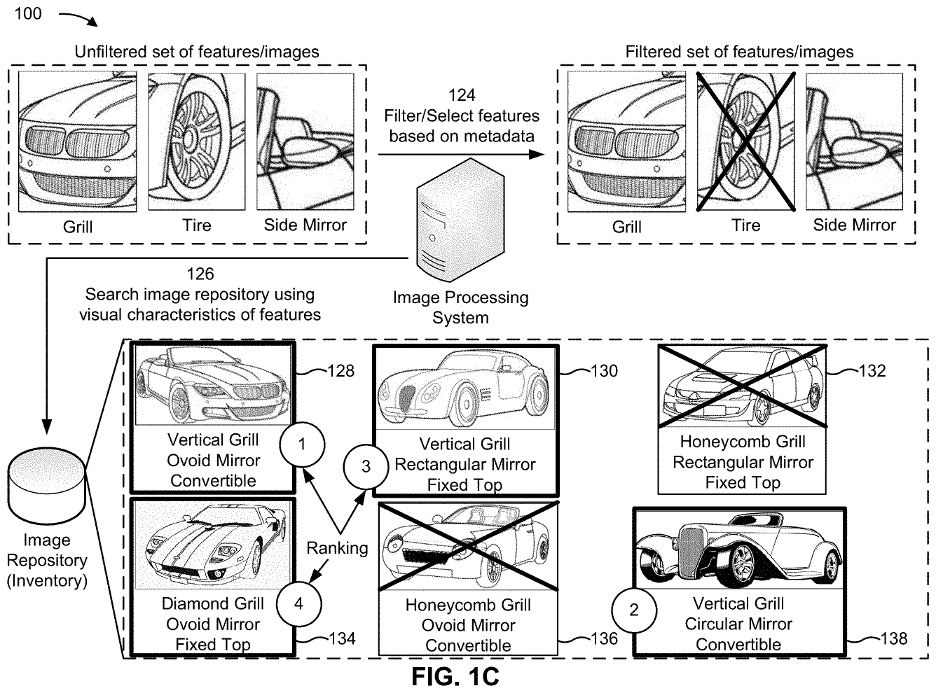

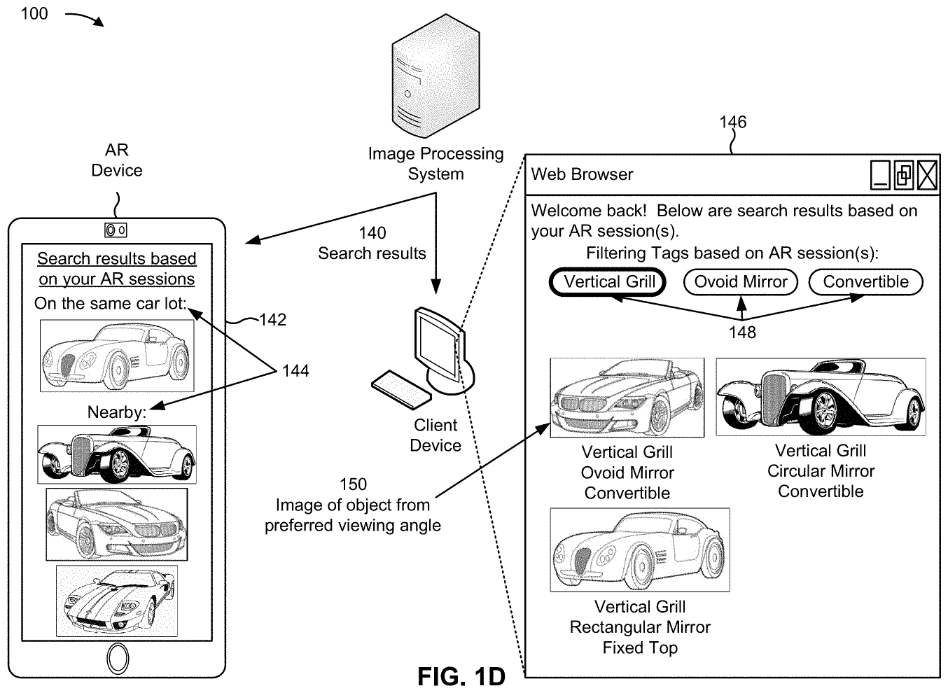

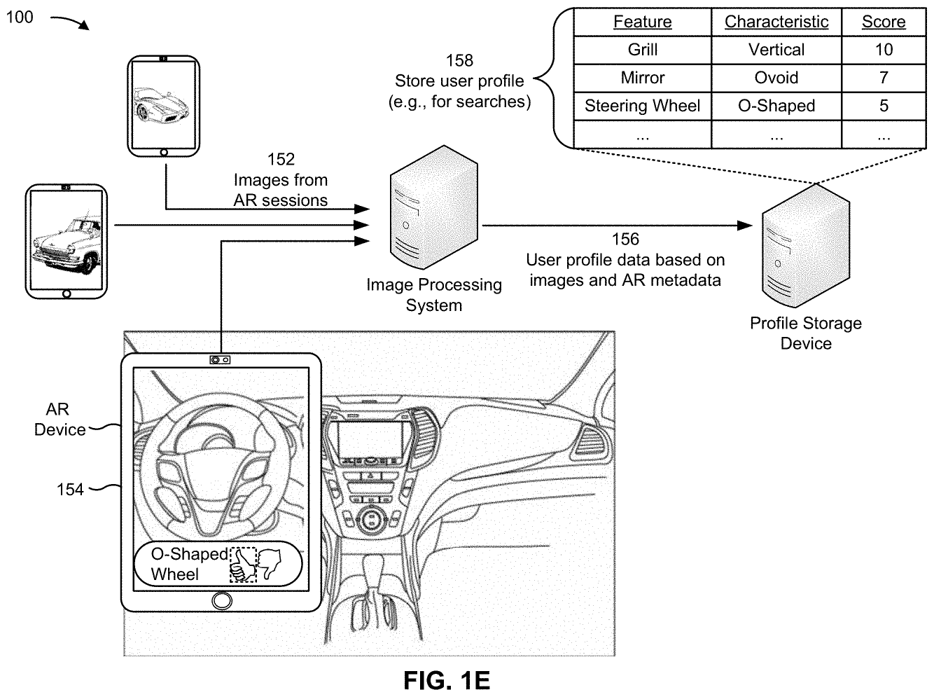

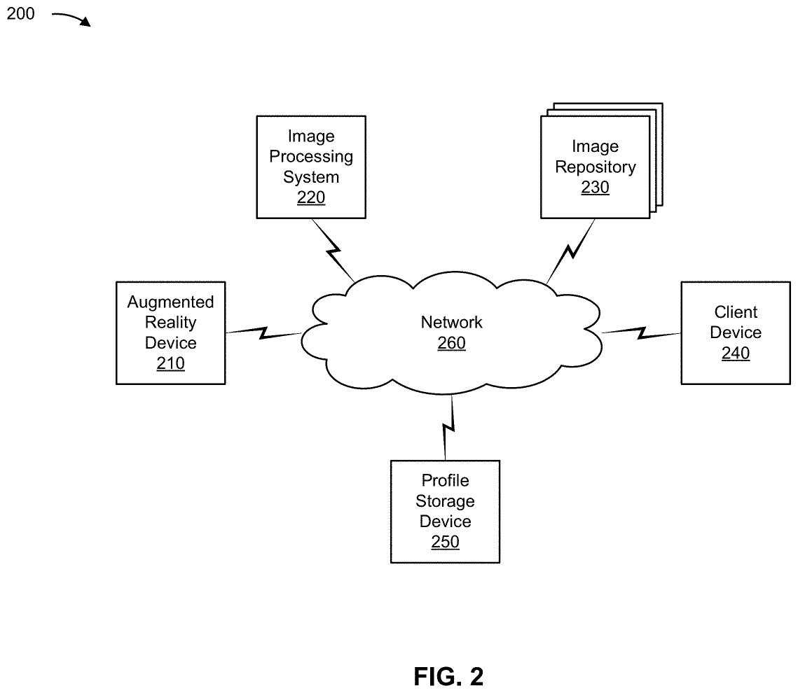

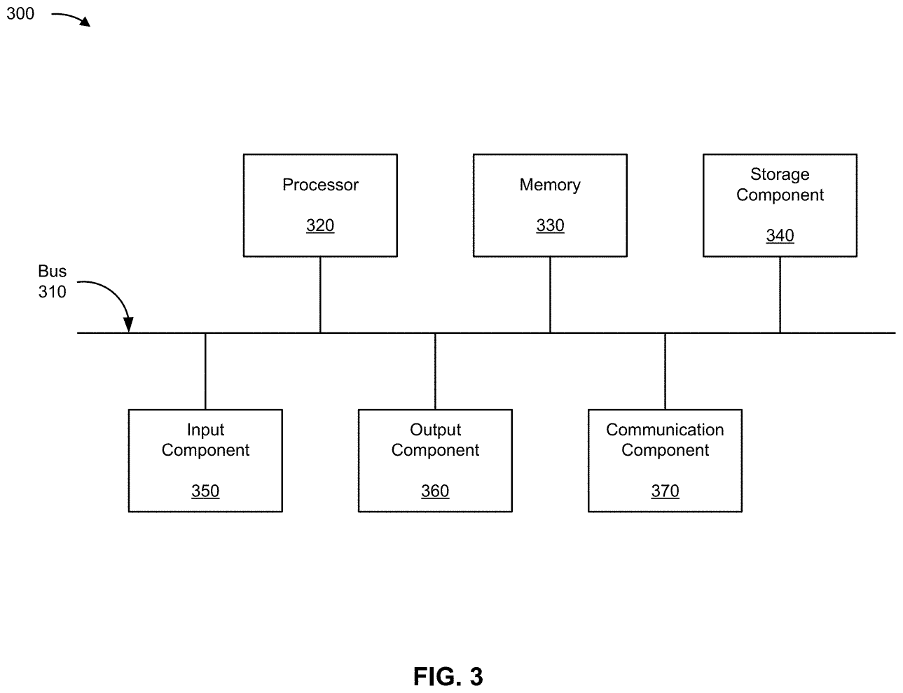

FIGS. 1A-1E are diagrams of an example implementation 100 associated with generating search results based on an AR session. As shown in FIGS. 1A-1E, example implementation 100 includes an image processing system, an AR device, an image repository, a client device, and a profile storage device. These devices are described in more detail below in connection with FIG. 2 and FIG. 3.

As shown in FIG. 1A, a user of the AR device may use the AR device to view an object in an AR session that overlays information on an image of the object (or a portion of the object) captured by the AR device (e.g., using a camera). The object may be a vehicle, such as a car (as shown in FIG. 1A), a motorcycle, a boat, or a plane. Alternatively, the object may be a consumer product, such as furniture, artwork, a television, a computer, or a mobile telephone. In general, the object may be any physical object capable of being viewed in an AR session. In some implementations, the user may interact with a user interface of the AR device to cause the AR device to execute an AR application for AR session.

In some implementations, the AR device (e.g., when providing the AR session) may capture a set of images associated with the object. For example, as shown in FIG. 1A, the AR device may obtain a set of images associated with a car. Each image, of the set of images, may include one or more features of the object. In some implementations, each image, of the set of images captured by the AR device, includes multiple features of the object. A feature of the object may include any visual element of the object that can be viewed and/or captured in an image. For example, as shown by reference number 102, an image of the car may include an upper grill (identified in the AR session as a vertical grill) and a lower grill (identified in the AR session as a honeycomb grill) captured from the front of the car. A feature of the object may be associated with a visual characteristic, such as a shape, a texture, a color, a color pattern, a curvature, a physical size, a luminosity, and/or a design.

In some implementations, the AR device may process an image to detect, determine, and/or identify one or more features of the object (e.g., one or more distinguishing features, customizable features, configurable features of the object, and/or the like that would be relevant to shopping or searching for the object). For example, with regard to reference number 102, the AR device may process an image using a computer vision technique, such as an object detection technique, to identify the upper grill and the lower grill. In an additional example, the AR device may determine that the upper grill is a vertical grill (e.g., the upper grill has a vertical configuration or design) and that the lower grill is a honeycomb grill (e.g., the lower grill has a honeycomb configuration or design). Although in some implementations the AR device may process an image to identify features, in some other implementations the image processing system may receive an image or image data from the AR device, process the image to detect features, and transmit, to the AR device, information that identifies the detected features.

Based on the detected features, the AR device may determine AR content, which may include information (e.g., text or graphics) to be overlaid on an image captured by the AR device and displayed on a user interface of the AR device. Alternatively, as shown by reference number 104, the AR device may receive AR content determined by the image processing system (e.g., based on one or more images transmitted from the AR device to the image processing system and/or one or more features included in the one or more images). In some implementations, the AR device and/or the image processing system may identify the AR content by performing a visual search, using an image as a search query, to identify the feature and/or a visual characteristic of the feature based on the image (e.g., using a data structure and/or a machine learning algorithm).

When providing the AR session, the AR device may present the AR content on an image (e.g., overlaid on a captured image) based on one or more identified features included in the image. For example, as shown by reference number 102, the AR device may present an image of the car (or a portion of the car) on the user interface of the AR device, and may overlay AR content on the image. In example implementation 100, the AR content includes a first AR overlay object that labels the upper grill of the car as a vertical grill and a second AR overlay object that labels the lower grill of the car as a honeycomb grill.

As further shown by reference number 102, an AR overlay object may include a set of AR feedback objects (shown as a “thumbs up” button and a “thumbs down” button). A user may interact with an AR feedback object, via the user interface of the AR device, to provide user input indicative of user feedback (e.g., approval or disapproval, desire or lack of desire, and/or preference or dislike) about a visual characteristic of a feature associated with the AR overlay object. For example, as shown by reference number 102, the user may interact with an AR feedback object of the first AR overlay object (e.g., by selecting the “thumbs up” button) to indicate approval, desire, and/or preference for a vertical grill. Additionally, the user may interact with an AR feedback object of the second AR overlay object (e.g., by selecting the “thumbs down” button) to indicate disapproval, lack of desire, and/or dislike for a honeycomb grill. The AR device may store the user feedback as feedback data, such as in a data structure (e.g., a database, an electronic file structure, and/or an electronic file, among other examples) of the AR device. Additionally, or alternatively, the AR device may transmit the feedback data to another device for storage, such as the profile storage device described elsewhere herein.

In some implementations, the AR device (e.g., when providing the AR session) may determine AR metadata associated with an image (sometimes referred to herein as “metadata”). For example, the AR device may determine AR metadata that is not based on a user interaction with the user interface of the AR device and/or that is not based on user interaction with AR content presented on the user interface. In some implementations, the AR metadata may be determined based on data that is measured using one or more measurement components (e.g., sensors) of the AR device, such as a clock, an accelerometer, a gyroscope, and/or a camera.

As an example, the metadata may include timing data that indicates a length of time that a feature is displayed via the user interface of the AR device. In some implementations, the AR device may associate a captured image with a timestamp that indicates a time at which the image was captured. In this example, the AR device may use a first timestamp of an initial image (e.g., earliest captured image) that includes the feature and a second timestamp of a final image (e.g., a latest captured image) that includes the feature to calculate the timing data (e.g., by determining a difference between the first timestamp and the second timestamp). In some implementations, this process may be performed multiple times if the AR device stops capturing images that include the feature (e.g., the feature goes out of view of the camera) and then later starts capturing images that include the feature (e.g., when a user comes back to view the feature at a later time, which could be part of the same AR session). Additionally, or alternatively, the AR device may determine the timing data using a clock (e.g., a timer) of the AR device and an image processor of the AR device to determine a length of time that a feature is being captured in an image (or a video that includes a sequence of images) and/or displayed via the user interface. In this example, the clock may start counting when an identified feature is being displayed, and may stop counting when the identified feature is no longer being displayed. Additionally, or alternatively, the AR device may capture a sequence of images using a fixed periodicity, and may determine the length of time based on the fixed periodicity and the number of images that include the feature (e.g., a periodicity of 5 seconds and 10 images that include the feature would result in 5×10=50 seconds that the feature is displayed).

All of the example described herein where the AR device determines the metadata may alternatively be performed by the image processing system based on receiving relevant information from the AR device. For the timing data, the AR device may transmit a set of images and corresponding timestamps and/or information that identifies the fixed periodicity, and the image processing system may determine the timing data based on this information, in a similar manner as described above in connection with the AR device determining the timing data. Thus, any operation described herein as the AR device determining metadata based on some information may also be performed by the image processing system based on receiving that information from the AR device.

Additionally, or alternatively, the metadata may include sequence data that indicates a sequence in which multiple features are displayed via the user interface. In some implementations, the AR device may associate captured images with respective sequence identifiers that indicate a sequence (or order) in which the images were captured (e.g., a sequence identifier of “1” for a first captured image, “2” for a second captured image, and so on). After identifying the features in the images, the AR device or the image processing system can use the sequence identifiers to determine a sequence in which the features were displayed via the user interface (e.g., with features included in earlier captured images being viewed earlier than features included in later captured images). Although some of the metadata is described in terms of a feature being displayed via the user interface (e.g., a length of time that the feature was displayed, a sequence in which features were displayed, etc.), this metadata can also be described in terms of a feature being captured by the AR device (e.g., a length of time that the feature was being captured, a sequence in which features were captured, etc.) or in terms of a feature being viewed by the user (e.g., a length of time that the feature was viewed, a sequence in which features were viewed, etc.)

Additionally, or alternatively, the metadata may include distance data that indicates a distance (e.g., a physical distance) between the feature and the AR device (e.g., when the feature is being captured in an image) and/or a distance between the object and the AR device (e.g., when the feature is being captured in an image). In some implementations, the AR device may associate a captured image with a distance indicator that indicates a distance between the AR device (e.g., one or more components of the AR device or a specific point on the AR device) and the feature and/or the object (e.g., a specific point on the feature or on a surface area the object). In some implementations, the AR device may determine the distance using a proximity sensor of the AR device, a radiofrequency component of the AR device (e.g., using radar), and/or a laser component of the AR device (e.g., using LIDAR), among other examples.

Additionally, or alternatively, the metadata may include size data that indicates a size of the feature. In some implementations, the size may be a size of the feature on the user interface, which may be indicated in terms of a number of pixels occupied by the feature in the image. Additionally, or alternatively, the size may indicated as a proportion of an image occupied by the feature, which may indicate a distance between the AR device and the feature (e.g., where a user shows interest in a feature by moving the AR device close to the feature) or may indicate a zoom level used to display the feature on the user interface (e.g., where a user shows interest in a feature by zooming in on the feature).

Additionally, or alternatively, the metadata may include quantity data that indicates a quantity of times that the feature is captured in an image during the AR session, among other examples. For example, the AR device may analyze a set of images captured during the AR session, and may count a number of times that the feature is captured in an image of the set of images. Additionally, or alternatively, the AR device may determine a number of times that the AR device stopped capturing images of the feature (e.g., for a threshold amount of time and/or a threshold number of images) and then later started capturing one or more images of the feature (e.g., at a later time during the AR session). This may indicate user interest in the feature because the user initially looks at the feature and then later comes back to look at the feature one or more times.

Additionally, or alternatively, the metadata may include orientation data that indicates an orientation of a feature in an image. The orientation may indicate an angle at which the feature was captured (e.g., straight on or at a particular angle). In some implementations, the AR device may determine the orientation data using radar or LIDAR and/or by comparing the image to other images of the feature with known angles or orientations. The AR device may associate a captured image with information that identifies the angle at which a feature appears in the image.

Additionally, or alternatively, the metadata may include position data that indicates a position of the feature within the image (e.g., a set of coordinates that indicates the position within the image) and/or a position of the feature with respect to one or more other features in the image (e.g., with images closer to the center of the image indicating higher importance). In some implementations, the AR device may analyze an image to determine the position of the feature using an image processing technique (e.g., to determine pixel coordinates of a center of the feature and/or another point on the feature). The AR device may associate an image with the position data determined for the image.

The AR device and/or the image processing system may use the AR metadata to determine importance of one or more features, as described in more detail elsewhere herein. This importance may be used to search for images of objects and return search results based on that search. This can enhance a user experience by providing relevant search results without requiring explicit input from the user (e.g., without requiring user interaction with a user interface to indicate the importance). In some implementations, the importance determined based on the AR metadata may be modified and/or enhanced based on explicit user input, as described in more detail below.

As shown by reference number 106, in a first example, the AR device may determine metadata based on a first set of images that include the upper grill and the lower grill of the car. The metadata may indicate that the first set of images was displayed on the user interface for 2 minutes during an AR session, that the first set of images was displayed first in a sequence on the user interface during the AR session, and that the upper grill and the lower grill were displayed from multiple angles and/or distances (e.g., 10 feet to 2 feet). In the first example, the user may interact with the user interface to provide explicit feedback regarding the first set of images (e.g., via the AR feedback objects of the first overlay object and the second overlay object that are respectively associated with the upper grill and the lower grill).

As shown by reference number 108, in a second example, the AR device may obtain a second set of images associated with a tire of the car (e.g., during the same AR session as described above in connection with the first example). As shown by reference number 110, the AR device may determine metadata associated with the second set of images, which may indicate that the second set of images was displayed on the user interface for 1 second during the AR session and that the second set of images was displayed second in the sequence. In the second example, the AR device does not present AR content overlaid on the image, and thus the user does not provide explicit feedback via AR content.

As shown by reference number 112, in a third example, the AR device may obtain a third set of images associated with a side mirror of the car (e.g., during the same AR session as described above in connection with the first example and the second example). In this example, the AR device may present an overlay object that labels the side mirror as an ovoid mirror and that includes a set of AR feedback objects (shown as a “thumbs up” button and a “thumbs down” button) over the third set of images. In the third example, the user does not interact with the overlay object displayed in connection with the side mirror. As shown by reference number 114, the AR device may determine metadata associated with the third set of images, which may indicate that the third set of images was displayed on the user interface for 30 seconds during the AR session, that the third set of images was displayed third in the sequence during the AR session, and that the side mirror was 1 foot from the AR device when captured in an image.

Turning to FIG. 1B, the AR device may send a set of images, captured during an AR session, to the image processing system. As shown by reference number 116, in some implementations, the AR device may send a full set of images (shown as an “unfiltered” set of images) that were captured by the AR device during the AR session (e.g., as described above in connection with FIG. 1A). In this example, the AR device transmits all of the captured images without filtering the captured images to the image processing system to identify a subset of images.

Alternatively, as shown by reference number 118, the AR device may send a filtered set of images (e.g., a subset of images of the set of captured images) captured by the AR device during the AR session. In this case, the AR device may analyze the full set of images to identify a subset of images that include important features (e.g., a threshold number of features with a highest importance score or one or more features for which a corresponding importance score satisfies a threshold). The AR device may then transmit, to the image processing system, only those images that include the important features. Details regarding determining an importance (e.g., an importance score) for one or more features are described below in connection with FIG. 1C. In this example, the AR device may perform one or more operations described below in connection with FIG. 1C as being performed by the image processing system to determine an importance of a feature.

As shown by reference number 120, the image processing system may process the set of images to detect one or more features of the object, in a similar manner as described above in connection with FIG. 1A. In example implementation 100, the detected features include the upper grill, the lower grill, the tire, and the side mirror of the car depicted in FIG. 1A.

As shown by reference number 122, the image processing system may determine metadata associated with the set of images, in a similar manner as described above in connection with FIG. 1A (e.g., by receiving, from the AR device, relevant information needed to determine the metadata). Alternatively, the image processing system may receive the metadata from the AR device in examples where the AR device determines the metadata. In some implementations, the image processing system may determine some metadata (e.g., metadata that is computationally expensive to determine) and may receive some other metadata from the AR device (e.g., metadata that is not computationally expensive). Additionally, or alternatively, the AR device may send feedback data to the image processing system based on a user interaction with the user interface.

As shown in FIG. 1C, and by reference number 124, the image processing system may filter an unfiltered and/or detected set of features to determine (e.g., identify or select) a filtered set of features. The filtered set of features may have a greater importance than (e.g., are of greater interest to a user of the AR device than) features that are not included in the filtered set of features, which may be determined based on the metadata and/or the feedback data. In some implementations, the image processing system may identify a filtered set of images that includes the filtered set of features. In some implementations, the image processing system may determine an importance score for each feature. The image processing system may then determine the filtered set of features as a threshold number of features with a highest importance score and/or as a set of features for which a corresponding importance score satisfies a threshold.

The image processing system may assign an importance score to a feature based on, for example, timing data, sequence data, distance data, size data, quantity data, orientation data, position data, and/or feedback data. For example, the image processing system may assign an importance score to a feature based on a duration of time that that the feature is displayed via the user interface (e.g., with a longer duration indicating greater importance than a shorter duration). Additionally, or alternatively, the image processing system may assign an importance score to a feature based on a sequence identifier that indicates an order in which the feature was captured in a sequence (e.g., with earlier captured features being assigned greater importance than later captured features). Additionally, or alternatively, the image processing system may assign an importance score to a feature based on a distance between the feature and the AR device or between the object and the AR device when the feature was captured in an image (e.g., with a smaller distance indicating greater importance than a greater distance).

Additionally, or alternatively, the image processing system may assign an importance score to a feature based on a size of the feature on the user interface (e.g., with a larger size indicating greater importance than a smaller size). Additionally, or alternatively, the image processing system may assign an importance score to a feature based on a quantity of times that the feature is captured in an image during the AR session (e.g., with a greater quantity indicating greater importance than a lesser quantity). Additionally, or alternatively, the image processing system may assign an importance score to a feature based on an angle at which the feature was captured (e.g., with a straight on angle indicating greater importance than a side angle). Additionally, or alternatively, the image processing system may assign an importance score to a feature based on a position of the feature within an image and/or relative to other features in the image (e.g., with a position closer to the center of the image indicating greater importance than a position farther away from the center of the image).

Additionally, or alternatively, the image processing system may assign an importance score to a feature based on feedback data for the feature, such as by assigning greater importance to a feature for which positive feedback was provided as compared to a feature for which no feedback was provided and/or for which negative feedback was provided, and/or by assigning greater importance to a feature for which no feedback was provided as compared to a feature for which negative feedback was provided. In some implementations, each category of feedback data may be associated with a corresponding first importance score, which may be combined with a second importance score that is determined based on metadata (and not feedback data) to determine an overall importance score for a feature.

Alternatively, each category of feedback data (e.g., positive, none, or negative as one example, or a feedback score input by the user as another example) may be associated with a fixed importance score, and that fixed importance score may override an importance score determined based on metadata. In this example, to conserve processing and memory resources, the image processing system may refrain from calculating an importance score for a feature based on metadata when the image processing system receives feedback data for that feature. Similarly, to conserve network resources, the AR device may refrain from transmitting metadata for a feature when feedback data is received for the feature, and may transmit only the feedback data (and not the metadata).

In the example of FIG. 1C, the image processing system includes the grill and the side mirror in the filtered set of features, and excludes the tire from the filtered set of features. The image processing system may exclude the tire because of a relatively low importance score determined based on viewing the tire second in sequence and viewing the tire for only 1 second. The image processing system may include the grill because of a relatively high importance score determined based on viewing the grill first in sequence, viewing the grill for 2 minutes, viewing the grill from multiple angles, and viewing the grill from a distance of 2 feet (as well as zooming in on the grill). The image processing system may include the side mirror because of a relatively high importance score determined based on viewing the side mirror for 30 seconds at a distance of 1 foot, despite viewing the side mirror third in sequence. In some implementations, different metadata may be assigned different weights for determining the importance score (e.g., timing data may be assigned a greater weight than sequence data in this example).

In some implementations, the image processing system may determine a range of importance scores for certain metadata based on a range of values determined for that metadata across the set of images captured during the AR session. For example, in example implementation 100, a viewing time of 2 minutes (e.g., the longest viewing time for any feature) may be associated with a highest importance score for timing data, while a viewing time of 1 second (e.g., the shortest viewing time for any feature) may be associated with a lowest importance score for timing data. The image processing system may assign a proportional importance score for other viewing times based on a comparison to the longest viewing time and the shortest viewing time. For example, where a viewing time of 1 second is associated with a score of 0, and a viewing time of 2 minutes (120 seconds) is associated with a score of 100, a viewing time of 30 seconds may be associated with a score of 25.

As shown by reference number 126, the image processing system may perform a search, using an image repository, based on the filtered set of features to identify a set of objects that have a same object category as the object (e.g., a car in example implementation 100) and that have at least one feature that shares a threshold degree of similarity with at least one feature of the filtered set of features. For example, each object, in the identified set of objects, may have at least one visual characteristic that is similar to a corresponding visual characteristic of at least one feature of the unfiltered set of features. In some implementations, the image processing system may determine the threshold degree of similarity based on performing one or more image analysis and/or image comparison techniques. Additionally, or alternatively, the image processing technique may use a trained machine learning model to identify the set of objects that have the same object category and/or that have one or more features that share a threshold degree of similarity (e.g., with respect to a visual characteristic) as the filtered set of features.

For example, the set of features in example implementation 100 includes an upper grill with a visual characteristic of vertical grill, a lower grill with a visual characteristic of honeycomb grill, and a side mirror with a visual characteristic of ovoid side mirror. The image processing system may search the image repository that includes images of cars 128-138. In some implementations, the image repository is associated with an inventory of one or more merchants, such as an inventory of cars associated with one or more car dealerships. As shown in FIG. 1C, car 128 may have a vertical grill, an ovoid side mirror, and a convertible roof style; car 130 may have a vertical grill, a rectangular side mirror, and a fixed top roof style; car 132 may have a honeycomb grill, a rectangular side mirror, and a fixed top roof style; car 134 may have a diamond grill, an ovoid side mirror, and a fixed top roof style; car 136 may have a honeycomb grill, an ovoid side mirror, and a convertible roof style; and car 138 may have a vertical grill, a circular side mirror, and a convertible roof style.

In example implementation 100, feedback data and/or metadata indicates that a vertical grill (e.g., a first visual characteristic of a grill feature) has a high importance score, and metadata indicates that an ovoid mirror has a medium importance score. Furthermore, feedback data and/or metadata indicates that a honeycomb grill (e.g., a second visual characteristic of a grill feature) has a low importance score or an importance score that indicates that features having the honeycomb grill are to be excluded from (or ranked lower in) search results. Accordingly, the image processing system may perform a search using the image repository based on these importance scores to identify a set of objects that have a feature that is similar to the higher importance features (e.g., a vertical grill and/or an ovoid mirror) and/or that do not have a feature that is similar to the lower importance features or the features to be excluded (e.g., the honeycomb grill). For example, as shown in FIG. 1C, the image processing system may search the image repository to identify a set of cars 128, 130, 134, and 138 that have a vertical grill and/or an ovoid side mirror. Furthermore, the image processing system may exclude, from the search results, information for cars 132 and 136, which have a honeycomb grill.

In some implementations, the image processing system may rank (e.g., sort) the set of objects and/or corresponding search results to generate ranked search results. For example, the image processing system may determine, for each object of the identified set of objects, a quantity of features of the object that are similar (e.g., have a threshold similarity) to the set of features. As another example, the image processing system may determine, for each object of the identified set of objects, a similarity score indicating how similar features of the object are to the set of features. Accordingly, the image processing system may rank the set of objects based on the respective quantity of similar features and/or similarity scores of the set of objects. As an example, as shown in FIG. 1C, the image processing system may rank car 128 with a highest ranking (shown as “1”) because car 128 has both a vertical grill and an ovoid side mirror (e.g., a highest number of matching visual characteristics), may rank car 138 with a second-highest ranking (shown as “2”) because car 138 has a vertical grill and a circular side mirror (which is similar to an ovoid side mirror), may rank car 130 with a third-highest ranking (shown as “3”) because car 130 has a vertical grill but not an ovoid mirror, and may rank car 134 with a fourth-highest ranking (shown as “4”_because car 134 has an ovoid side mirror but not a vertical grill. In this example, because the grill has a higher importance than the side mirror, car 130 is ranked higher than car 134 because car 130 has a matching grill.

As shown in FIG. 1D, and by reference number 140, the image processing system may send search results that identify the set of objects (e.g., images and/or descriptions associated with the set of objects) to the AR device and/or another device, such as a client device. For example, the image processing system may send ranked search results that identify the ranked set of objects to the AR device and/or the client device. As shown by reference number 142, the AR device may cause the search results to be displayed on a user interface of the AR device. In some implementations, the search results may be displayed according to the ranking.

In some implementations, the AR device may send location information (e.g., global positioning system data) that identifies a location of the AR device (e.g., a physical location of the AR device when providing the AR session) to the image processing system. The image processing system may process the location information to determine a location associated with the object (e.g., that is the subject of a set of images captured by the AR device during the AR session). The image processing system may obtain inventory information associated with the set of objects (e.g., from a data structure associated with the image processing system) and may determine, based on the inventory information, a set of locations corresponding to the set of objects. For example, when the set of objects is a set of cars (e.g., that includes cars 128-138, as described herein in relation to FIG. 1C), the inventory information may identify dealerships for the set of cars, and the image processing system may determine locations of the dealerships to determine the set of locations corresponding to the set of cars.

Accordingly, the image processing system may determine respective distances between the AR device and the set of objects and may rank the set of objects based on distance from the AR device (e.g., from closest to the AR device to farthest from the AR device). The image processing system then may send ranked search results that identify the ranked set of objects based on distance to the AR device. For example, as shown by reference number 144, the AR device may display images of cars located in a same car lot and/or dealership as the AR device (e.g., within a threshold proximity of the AR device) in a first area of the user interface, and may display images of cars located in different car lots and/or dealerships in a second area of the user interface. In some implementations, the locations of objects with respect to the AR device may be used as a factor in ranking search results.

As shown by reference number 146, the client device may execute a web browser or another application that allows the client device and the image processing system (or a web server in communication with the image processing system) to communicate. The client device may receive search results from the image processing system. As shown by reference number 148, a user of the client device may provide input to filter the search results for display on the client device (e.g., via the user interface of the client device). For example, the image processing system may provide user interface information that identifies filter buttons associated with the set of features and/or visual characteristics. A user of the client device may interact with the filter buttons to cause the user interface to display only search results that have features associated with the filter buttons. For example, as shown in FIG. 1D, a user of the client device may interact with a “vertical grill” button to cause the web session to display search results associated with cars that have vertical grills (and to refrain from displaying search results associated with cars that do not have vertical grills).

As shown by reference number 150, in some implementations, the AR metadata may indicate a preferred viewing angle of a user with respect to an object. For example, the AR device and/or the image processing system may determine the preferred viewing angle based on analyze a set of images from an AR session to determine a viewing angle, of a set of viewing angles, associated with a longest duration of time (e.g., similar to timing data described elsewhere herein). In some implementations, the search results may be provided for display using images that match the preferred viewing angle.

As shown in FIG. 1E, and by reference number 152, the image processing system may receive, from the AR device, respective sets of images from multiple AR sessions. For example, a user of the AR device may interact with the AR device to execute an application to provide AR session for multiple cars. The AR device may perform operations described above in connection with FIGS. 1A and 1B for each car. In this way, the image processing system may obtain multiple sets of images associated with multiple objects.

In some implementations, the AR device may present AR content and/or determine metadata for each AR session of the multiple AR sessions, in a similar manner as that described herein in relation to FIGS. 1A and 1B. For example, as shown by reference number 154, the AR device may present, over a set of images associated with a car interior and captured by the AR device during an AR session, an AR overlay object that labels a steering wheel of the car as an O-shaped wheel and that includes a set of AR overlay objects (shown as a “thumbs up” button and a “thumbs down” button). The AR device and/or the image processing system may determine metadata associated with the set of images in a similar manner as that described herein in relation to FIGS. 1A and 1B. In this way, the image processing system may obtain metadata associated with the multiple objects.

As shown by reference number 156, the image processing system may determine user profile data for the user based on the multiple AR sessions (or based on a single AR session, in some implementations), and may transmit the user profile data to a profile storage device. For example, the image processing system may process the multiple sets of images associated with the multiple objects and/or the metadata associated with the multiple objects to determine the user profile data. As shown by reference number 158, the user profile data may identify one or more features of the multiple objects, a respective characteristic (e.g., a visual characteristic) of the one or more features, and/or a respective score associated with the one or more features (e.g., indicative of an importance score, described elsewhere herein). The user profile data may be stored by the profile storage device and/or the image processing system. The user profile data may be used for subsequent processing. For example, the image processing system may obtain the user profile from the profile storage device and search the image repository, based on the user profile, to provide search results to the AR device and/or the client device, in a similar manner as that described herein in relation to FIGS. 1C-1D. By using data from multiple AR sessions to build a user profile represented by the user profile data, the image processing system may further improve relevance of search results.

In this way, the image processing system may provide the user of the AR device with relevant and/or optimal search results (e.g., search results that are associated with object features that are important to the user and/or that have visual characteristics that are important to the user). Further, by basing a search on metadata that does not include information concerning user interactions with the AR device (e.g., user interactions with AR content presented during the AR session), the image processing system may identify object features that are important to the user that the user may not explicitly know are important to the user and/or without requiring the user to provide explicit feedback indicating what is important to the user. This increases a likelihood that the user will find the search results to be relevant and/or optimal even if the user does not explicitly input a search query. This may conserve resources that may have otherwise been wasted to display sub-optimal search results that would not be of interest to the user, and/or may conserve resources that would be wasted when the sub-optimal results caused the user to continue searching for images of other objects.

As indicated above, FIGS. 1A-1E are provided merely as one or more examples. Other examples may differ from what is described with regard to FIGS. 1A-1E. For example, there may be additional devices and/or networks, fewer devices and/or networks, different devices and/or networks, or differently arranged devices and/or networks than those shown in FIGS. 1A-1E. Furthermore, two or more devices shown in FIGS. 1A-1E may be implemented within a single device, or a single device shown in FIGS. 1A-1E may be implemented as multiple and/or distributed devices. Additionally, or alternatively, a set of devices (e.g., one or more devices) included in the one or more example implementations 100 may perform one or more functions described as being performed by another set of devices included in the one or more example implementations 100.

FIG. 2 is a diagram of an example environment 200 in which systems and/or methods described herein may be implemented. As shown in FIG. 2, environment 200 may include an augmented reality (AR) device 210, an image processing system 220, one or more image repositories 230, a client device 240, a profile storage device 250, and a network 260. Devices of environment 200 may interconnect via wired connections, wireless connections, or a combination of wired and wireless connections.

The AR device 210 includes one or more devices capable of receiving, generating, storing, processing, and/or providing information associated with an AR session, as described elsewhere herein. The AR device 210 may include a communication device and/or a computing device. For example, the AR device 210 may include a wireless communication device, a mobile phone, a user equipment, a laptop computer, a tablet computer, a gaming console, a wearable communication device (e.g., a smart wristwatch, a pair of smart eyeglasses, a head mounted display, or a virtual reality headset), or a similar type of device. The AR device 210 may include one or more image capture devices (e.g., a camera, such as a video camera) configured to obtain one or more images of one or more objects in a field of view of the one or more image capture devices. The AR device 210 may execute an application to capture images (e.g., video) and to provide an AR session in which AR content is overlaid on the captured images via a user interface of the AR device 210.

The image processing system 220 includes one or more devices capable of receiving, generating, storing, processing, providing, and/or routing information associated with generating search results based on an AR session, as described elsewhere herein. The image processing system 220 may include a communication device and/or a computing device. For example, the image processing system 220 may include a server, such as an application server, a client server, a web server, a database server, a host server, a proxy server, a virtual server (e.g., executing on computing hardware), or a server in a cloud computing system. In some implementations, the image processing system 220 includes computing hardware used in a cloud computing environment.

The image repository 230 includes one or more devices capable of receiving, generating, storing, processing, and/or providing images of objects and/or information associated with images of objects, as described elsewhere herein. The image repository 230 may include a communication device and/or a computing device. For example, the image repository 230 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The image repository 230 may communicate with one or more other devices of environment 200, as described elsewhere herein.

The client device 240 includes one or more devices capable of receiving, generating, storing, processing, and/or providing information associated with displaying search results, as described elsewhere herein. The client device 240 may include a communication device and/or a computing device. For example, the client device 240 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The profile storage device 250 includes one or more devices capable of receiving, generating, storing, processing, and/or providing user profile data, as described elsewhere herein. The profile storage device may include a communication device and/or a computing device. For example, the profile storage device 250 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The profile storage device 250 may communicate with one or more other devices of environment 200, as described elsewhere herein.

The network 260 includes one or more wired and/or wireless networks. For example, the network 260 may include a cellular network, a public land mobile network, a local area network, a wide area network, a metropolitan area network, a telephone network, a private network, the Internet, and/or a combination of these or other types of networks. The network 260 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300, which may correspond to AR device 210, image processing system 220, image repository 230, client device 240, and/or profile storage device 250. In some implementations, AR device 210, image processing system 220, image repository 230, client device 240, and/or profile storage device 250 may include one or more devices 300 and/or one or more components of device 300. As shown in FIG. 3, device 300 may include a bus 310, a processor 320, a memory 330, a storage component 340, an input component 350, an output component 360, and a communication component 370.

Bus 310 includes a component that enables wired and/or wireless communication among the components of device 300. Processor 320 includes a central processing unit, a graphics processing unit, a microprocessor, a controller, a microcontroller, a digital signal processor, a field-programmable gate array, an application-specific integrated circuit, and/or another type of processing component. Processor 320 is implemented in hardware, firmware, or a combination of hardware and software. In some implementations, processor 320 includes one or more processors capable of being programmed to perform a function. Memory 330 includes a random access memory, a read only memory, and/or another type of memory (e.g., a flash memory, a magnetic memory, and/or an optical memory).

Storage component 340 stores information and/or software related to the operation of device 300. For example, storage component 340 may include a hard disk drive, a magnetic disk drive, an optical disk drive, a solid state disk drive, a compact disc, a digital versatile disc, and/or another type of non-transitory computer-readable medium. Input component 350 enables device 300 to receive input, such as user input and/or sensed inputs. For example, input component 350 may include a touch screen, a keyboard, a keypad, a mouse, a button, a microphone, a switch, a sensor, a global positioning system component, an accelerometer, a gyroscope, and/or an actuator. Output component 360 enables device 300 to provide output, such as via a display, a speaker, and/or one or more light-emitting diodes. Communication component 370 enables device 300 to communicate with other devices, such as via a wired connection and/or a wireless connection. For example, communication component 370 may include a receiver, a transmitter, a transceiver, a modem, a network interface card, and/or an antenna.

Device 300 may perform one or more processes described herein. For example, a non-transitory computer-readable medium (e.g., memory 330 and/or storage component 340) may store a set of instructions (e.g., one or more instructions, code, software code, and/or program code) for execution by processor 320. Processor 320 may execute the set of instructions to perform one or more processes described herein. In some implementations, execution of the set of instructions, by one or more processors 320, causes the one or more processors 320 and/or the device 300 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 3 are provided as an example. Device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

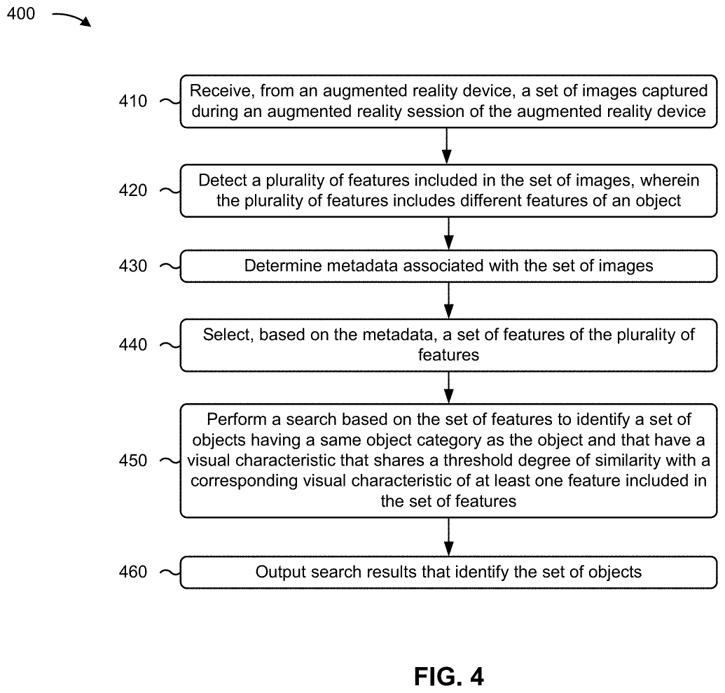

FIG. 4 is a flowchart of an example process 400 associated with generating search results based on an AR session. In some implementations, one or more process blocks of FIG. 4 may be performed by image processing system 220. In some implementations, one or more process blocks of FIG. 4 may be performed by another device or a group of devices separate from or including image processing system 220, such as AR device 210, image repository 230, client device 240, and/or profile storage device 250. Additionally, or alternatively, one or more process blocks of FIG. 4 may be performed by one or more components of device 300, such as processor 320, memory 330, storage component 340, input component 350, output component 360, and/or communication component 370.

As shown in FIG. 4, process 400 may include receiving, from an augmented reality device, a set of images captured during an augmented reality session of the augmented reality device (block 410). As further shown in FIG. 4, process 400 may include detecting a plurality of features included in the set of images, wherein the plurality of features includes different features of an object (block 420). As further shown in FIG. 4, process 400 may include determining metadata associated with the set of images (block 430). In some implementations, the metadata indicates a relative importance of a first feature, of the plurality of features, as compared to a second feature, of the plurality of features, based on augmented reality session data other than a user interaction with a user interface of the augmented reality device to explicitly indicate the relative importance.

As further shown in FIG. 4, process 400 may include selecting, based on the metadata, a set of features of the plurality of features (block 440). As further shown in FIG. 4, process 400 may include performing a search based on the set of features to identify a set of objects having a same object category as the object and that have a visual characteristic that shares a threshold degree of similarity with a corresponding visual characteristic of at least one feature included in the set of features (block 450). As further shown in FIG. 4, process 400 may include outputting search results that identify the set of objects (block 460).

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

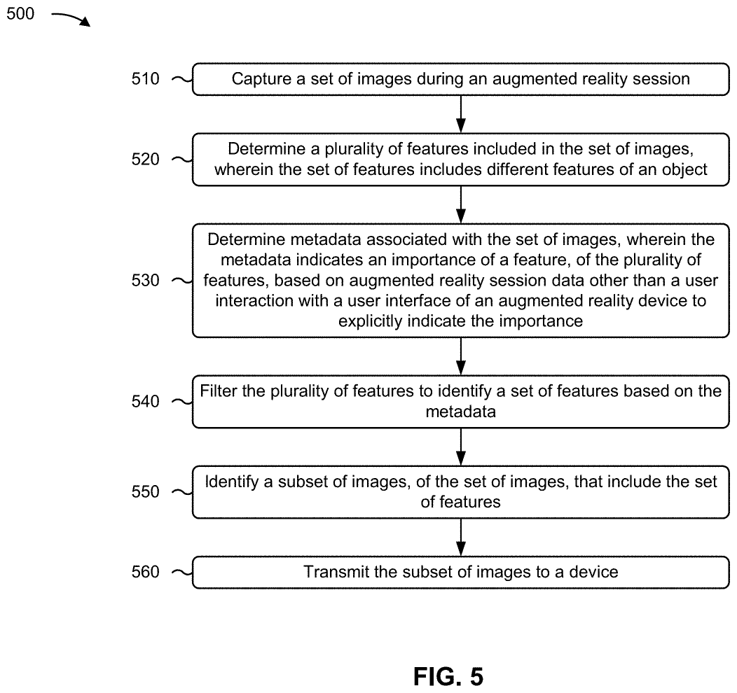

FIG. 5 is a flowchart of an example process 500 associated with generating search results based on an AR session. In some implementations, one or more process blocks of FIG. 5 may be performed by AR device 210. In some implementations, one or more process blocks of FIG. 5 may be performed by another device or a group of devices separate from or including AR device 210, such as image processing system 220, image repository 230, client device 240, and/or profile storage device 250. Additionally, or alternatively, one or more process blocks of FIG. 5 may be performed by one or more components of device 300, such as processor 320, memory 330, storage component 340, input component 350, output component 360, and/or communication component 370.

As shown in FIG. 5, process 500 may include capturing a set of images during an augmented reality session (block 510). As further shown in FIG. 5, process 500 may include determining a plurality of features included in the set of images, wherein the plurality of features includes different features of an object (block 520). As further shown in FIG. 5, process 500 may include determining metadata associated with the set of images, wherein the metadata indicates an importance of a feature, of the plurality of features, based on augmented reality session data other than a user interaction with a user interface of the augmented reality device to explicitly indicate the importance (block 530). As further shown in FIG. 5, process 500 may include filtering the plurality of features to identify a set of features based on the metadata (block 540). As further shown in FIG. 5, process 500 may include identifying a subset of images, of the set of images, that include the set of features (block 550). As further shown in FIG. 5, process 500 may include transmitting the subset of images to a device (block 560).

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description, but is not intended to be exhaustive or to limit the implementations to the precise form disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, etc., depending on the context.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, etc.), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for generating search results based on data captured by an augmented reality device, the system comprising:
a memory; and
one or more processors, communicatively coupled to the memory, configured to:
receive a set of images captured by the augmented reality device;
detect a set of features included in the set of images, wherein the set of features includes different features of an object associated with an object category;
determine metadata associated with the set of images, wherein the metadata includes at least one of:
timing data that indicates a length of time that a detected feature, of the set of features, is displayed via a user interface of the augmented reality device,
sequence data that indicates a sequence in which two or more features, of the set of features, are displayed via the user interface,
distance data that indicates a distance between a detected feature, of the set of features, and the augmented reality device, or
size data that indicates a size of a detected feature, of the set of features,
on the user interface;
select one or more detected features, of the set of features, based on the metadata;
perform a search using an image repository and based on the one or more detected features to identify a set of objects associated with the object category; and
transmit search results that identify the set of objects.

2. The system of claim 1, wherein the metadata includes the timing data, the sequence data, the distance data, and the size data.

3. The system of claim 1, wherein the one or more processors are further configured to:
determine one or more visual characteristics corresponding to the one or more detected features; and
wherein the one or more processors, when performing the search, are configured to:
perform the search based on the one or more visual characteristics to identify the set of objects, wherein the set of objects include features having visual characteristics that have a threshold degree of similarity with the one or more visual characteristics.

4. The system of claim 1, wherein the one or more processors are further configured to:
determine a visual characteristic corresponding to a feature included in an image being captured by the augmented reality device; and
transmit, to the augment reality device, information that identifies the visual characteristic to cause the augmented reality device to display the information that identifies the visual characteristic for display.

5. The system of claim 1, wherein the one or more processors are further configured to:
receive user input provided via the user interface of the augmented reality device, wherein the user input indicates a desired visual characteristic or an undesired visual characteristic associated with a feature of the set of features; and
wherein the one or more processors, when performing the search, are configured to perform the search based on the user input.

6. The system of claim 1, further comprising ranking the search results, based on the metadata, to generate ranked search results; and
wherein the one or more processors, when transmitting the search results, are configured to transmit the ranked search results.

7. The system of claim 1, wherein the one or more processors are further configured to:
receive location information that identifies a location of the augmented reality device;
determine a set of locations corresponding to the set of objects based on inventory information;
sort the search results based on the location information and the set of locations to generate sorted search results; and
wherein the one or more processors, when transmitting the search results, are configured to transmit the sorted search results.

8. A method for generating search results based on data captured by an augmented reality device, comprising:
receiving, by a system and from the augmented reality device, a set of images captured during an augmented reality session of the augmented reality device;
detecting, by the system, a plurality of features included in the set of images, wherein the plurality of features includes different features of an object;
determining, by the system, metadata associated with the set of images, wherein the metadata indicates a relative importance of a first feature, of the plurality of features, as compared to a second feature, of the plurality of features, based on augmented reality session data other than a user interaction with a user interface of the augmented reality device to explicitly indicate the relative importance;
selecting, by the system and based on the metadata, a set of features of the plurality of features;
performing, by the system, a search based on the set of features to identify a set of objects having a same object category as the object and that have a visual characteristic that shares a threshold degree of similarity with a corresponding visual characteristic of at least one feature included in the set of features; and
outputting, by the system, search results that identify the set of objects.

9. The method of claim 8, wherein the metadata includes timing data that indicates at least one of:
a first length of time that the first feature is displayed via the user interface of the augmented reality device, or
a second length of time that the second feature is displayed via the user interface of the augmented reality device.

10. The method of claim 8, wherein the metadata includes sequence data that indicates a sequence in which the first feature and the second feature are displayed via the user interface of the augmented reality device.

11. The method of claim 8, wherein the metadata includes distance data that indicates at least one of:
a first distance between the first feature and the augmented reality device, or
a second distance between the second feature and the augmented reality device.

12. The method of claim 8, wherein the metadata includes size data that indicates at least one of:
a size of the first feature in an image of the set of images,
a proportion of an image, of the set of images, occupied by the first feature,
a size of the second feature in an image of the set of images, or
a proportion of an image, of the set of images, occupied by the second feature.

13. The method of claim 8, wherein the metadata includes quantity data that indicates at least one of:
a quantity of images, of the set of images, that include the first feature, or
a quantity of images, of the set of images, that include the second feature.

14. The method of claim 8, wherein the metadata is determined based on a plurality of augmented reality sessions, associated with a same user as the augmented reality session, in which different objects are viewed.

15. The method of claim 8, wherein the metadata is not received from the augmented reality device.

16. The method of claim 8, further comprising:
determining user profile information, for a user associated with the augmented reality session, based on the metadata; and
storing the user profile information.

17. A non-transitory computer-readable medium storing a set of instructions, the set of instructions comprising:
one or more instructions that, when executed by one or more processors of an augmented reality device, cause the augmented reality device to:
capture a set of images during an augmented reality session;
determine a plurality of features included in the set of images, wherein the plurality of features includes different features of an object;
determine metadata associated with the set of images, wherein the metadata indicates an importance of a feature, of the plurality of features, based on augmented reality session data other than a user interaction with a user interface of the augmented reality device to explicitly indicate the importance;
filter the plurality of features to identify a set of features based on the metadata;
identify a subset of images, of the set of images, that include the set of features; and
transmit the subset of images to a device.

18. The non-transitory computer-readable medium of claim 17, wherein the one or more instructions, when executed by the one or more processors, further cause the augmented reality device to:
receive search results from the device based on transmitting subset of images to the device; and
output the search results.

19. The non-transitory computer-readable medium of claim 17, wherein the metadata includes at least one of:
a length of time that the feature is displayed via the user interface,
a sequence in which the feature and another feature are displayed via the user interface,
a distance between the feature and the augmented reality device,
a distance between the object and the augmented reality device when the feature is captured in an image,
a size of the feature on the user interface,
a proportion of the user interface occupied by the feature,
a quantity of times that the feature is captured in an image during the augmented reality session.

20. The non-transitory computer-readable medium of claim 17, wherein the one or more instructions, when executed by the one or more processors, cause the augmented reality device to:
receive user input that indicates a desired visual characteristic or an undesired visual characteristic associated with another feature of the plurality of features; and
wherein the one or more instructions, that cause the augmented reality device to filter the plurality of features to identify the set of features, further cause the augmented reality device to: filter the plurality of features to identify the set of features based on the metadata and the user input.
